(19) United States
(12) Patent Application Publication
(10) Pub. No.: US 2006/0273226 A1
(43) Pub. Date: Dec. 7, 2006

(54) Attachment device for a line

(75) Inventor: Stefan Jatzke, Ebertsheim (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/442,846

(22) Filed: May 30, 2006

(30) Foreign Application Priority Data
Jun. 1, 2005 (DE) 20 2005 008 570.7

(51) Int. Cl. F16L 3/22

(52) U.S. Cl. 248/68.1

(57) ABSTRACT

An attachment device (10) for one or a plurality of lines includes a reinforcement part (12) and a synthetic layer (14) which at least partially surrounds the reinforcement part (12). A respective retainer is provided for each line. The reinforcement part (12) has a C-shaped section (18, 20), as seen in cross-section, for each retainer. Each C-shaped section (18, 20) surrounds the respective line spaced apart from the line. The synthetic layer (14) has a peripheral wall (32) which surrounds the inserted line and has appendages (36) extending inwards. The appendages (36) have a sickle-like shape and are flexible. The reinforcement part (12) has an attachment section (22) for a bolt. The synthetic layer (14) fully surrounds the reinforcement part (12) except for the attachment section (22). The synthetic layer (14) has a cylindrical opening (24) formed therein for accommodating the bolt.

### TECHNICAL FIELD

The invention relates to an attachment device for one or more lines.

### BACKGROUND OF THE INVENTION

Different attachment devices are known for the attachment of lines, such as hydraulic lines and electric wires in vehicles, especially for attachment to a vehicle body. There are different requirements on such devices. On the one hand, they are required to provide sufficient holding forces for lines, even in higher temperature ranges. On the other hand, it should be possible to produce them inexpensively, and they must not have any sharp edges so as to minimize the risk of injury for a fitter.

DE-U-89 00 984 discloses an attachment device having an elastically bendable holding block. The holding block is divided into two separate block halves, which are spaced apart from each other. The block halves are held together by an embedded stabilizing body which is fully exposed in a certain region. Despite the stabilizing body, the forces for holding the lines are predefined solely by the material and the shape of the holding block. To increase the holding forces, a more rigid material could be selected for the holding block; this, however, has an adverse effect on the damping characteristics thereof.

DE-U-299 05 707 discloses an attachment device having several line retainers. The walls of the line retainers are made to have simple ribs, which do not provide for satisfactory adaptation to different line diameters.

It is an object of the invention to provide an attachment device for one or more lines which is inexpensive, and at the same time fulfils the above requirements.

### BRIEF DESCRIPTION OF THE INVENTION

According to a first aspect of the invention, an attachment device for a plurality of lines comprises a reinforcement part and a synthetic layer which at least partially surrounds the reinforcement part. A respective retainer is provided for each line. The reinforcement part has a C-shaped section, as seen in cross-section, for each retainer. Each C-shaped section surrounds the respective line spaced apart from the line. The C-shaped sections encompass the line with a high and constant holding force.

According to a second aspect of the invention, an attachment device for a line comprises a reinforcement part and a synthetic layer which at least partially surrounds the reinforcement part. The synthetic layer has a peripheral wall which surrounds the inserted line and has appendages extending inwards. The appendages have a sickle-like shape and are flexible. The appendages make it possible for lines with different line diameters to be inserted and held securely. Thus, with a line with a small diameter, the appendages are not bent, or are only slightly bent, and touch the outer side of the line with their tips, whereas with a larger line diameter, the appendages are bent (to a greater extent). In both cases, the line is securely and firmly encompassed.

According to a third aspect of the invention, an attachment device for a line comprises a reinforcement part and a synthetic layer. The reinforcement part has an attachment section. The synthetic layer fully surrounds the reinforcement part except for the attachment section. Any sharp edges of the reinforcement part which is made, e.g., from metal, are covered by the synthetic layer so that the risk of injury is minimized for a fitter. Furthermore, the lines, which are fully surrounded by the synthetic layer, are separated from the vibrations of the vehicle body, i.e. the synthetic layer surrounding the reinforcement part acts as a vibration damper.

According to a fourth aspect of the invention, an attachment device for a line comprises a reinforcement part and a synthetic layer which at least partially surrounds the reinforcement part. The reinforcement part has an attachment section for a bolt. The synthetic layer has a cylindrical opening formed therein for accommodating the bolt.

The reinforcement part is preferably made from metal. Even in higher temperature ranges, metal is temperature-resistant so that there is no deterioration of the holding forces.

Alternatively, the reinforcement part is made from a synthetic, for example a glass fiber reinforced polyamide. The synthetic used as the reinforcement part is harder and more temperature-resistant here than the synthetic layer which surrounds the reinforcement part.

It is advantageous to provide the attachment device with a gap for inserting the line. The gap makes it possible to insert the line easily without the need for, e.g., a flap-type element which has to be opened and then closed again after the line has been inserted.

Preferably, the attachment device accommodates several lines, as is required in the case of brake lines, for example.

### BRIEF DESCRIPTION OF THE DRAWINGS

FIG. 1 shows a perspective view of an attachment device according to the invention;

FIG. 2 shows a side view of the attachment device;

FIG. 3 shows a sectional view of the attachment device along line III-III in FIG. 2;

FIG. 4 shows a side view of the attachment device; and

FIG. 5 shows a perspective view of a reinforcement part of the attachment device.

### DETAILED DESCRIPTION OF THE INVENTION

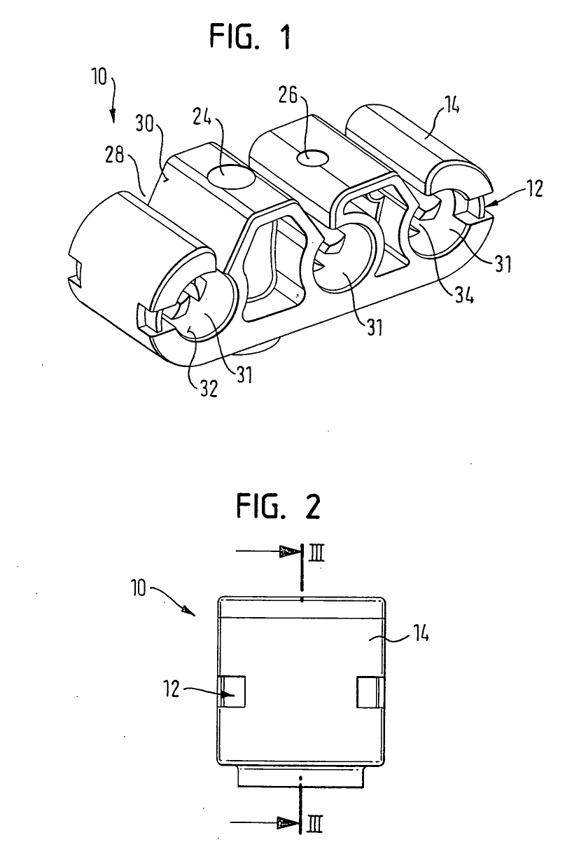

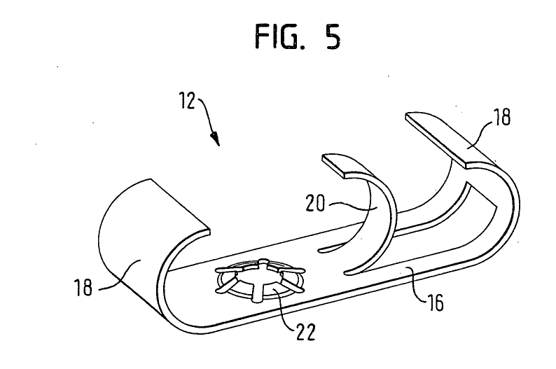

FIG. 1 shows an attachment device 10 which can accommodate three lines and which consists of a reinforcement part 12 (see FIG. 5) and a synthetic layer 14 which surrounds the reinforcement part 12.

The reinforcement part 12, which is embedded in the synthetic layer 14, is made from metal; however, it could also be made from a glass fiber reinforced polyamide, for example. At any rate, the material of the reinforcement part 12 is harder than the material of the synthetic layer 14.

The reinforcement part 12 has a flat section 16 which on both sides continues into C-shaped sections 18, the flat section 16 also having a C-shaped section 20, as seen in cross-section, which is formed by a central strip of the flat section 16 being stamped out and bent upwards. Because of this, the width of the central C-shaped section 20 is less than that of the two outer C-shaped sections 18.

The flat section 16 also has an attachment section 22 which is in the form of a spring collar, and which can engage with a bolt (not shown) when the attachment device 10 is fitted.

The reinforcement part 12 is embedded in the synthetic layer 14 with the exception of the attachment section 22. That is, the synthetic layer 14 fully surrounds the reinforcement part 12 except for the attachment section 22, more precisely, except for axial end faces (in relation to the axis of the opening 24 which will be discussed further below) of the attachment section 22. The synthetic layer 14 here is preferably an injection molded TPE-V layer (thermoplastic elastomer vulcanizate).

The lower side (according to FIG. 4) of the attachment device 10 is formed to be straight so as to ensure a flat support of the attachment device 10 on the vehicle body.

The two outer C-shaped sections 18 are surrounded by the synthetic layer 14 of constant thickness so that the outer sides of the attachment device 10 are rounded off.

The upper side (according to FIG. 4) of the attachment device 10 is provided with two cylindrical openings 24, 26, the first opening 24 extending over the whole height of the attachment device 10 and serving to receive the bolt (not shown). The second opening 26, on the other hand, is necessary, for reasons relating to production, in order to hold the reinforcement part 12 during injection molding, and so only extends up to the reinforcement part 12.

The fact that the bolt is accommodated in the synthetic layer 14 results in a reduction of the vibrations transferred from the vehicle body, to which the attachment device 10 is secured by means of the bolt. In addition, any vibrations or pulsations of the lines inserted are less easily transferred to the bolt. Furthermore, the arrangement and configuration of the opening 24 has the advantage that the bolt, arranged perpendicularly between two line retainers, serves as a support for the lines both during insertion and in the fitted condition of the lines.

In addition, the upper side of the attachment device 10 is penetrated by three oblong gaps 28 (see FIG. 1) which extend over the whole width of the attachment device 10 and which each have an inclined wall 30 which facilitates the insertion of the lines. The oblong gaps 28 each continue into a cylindrical recess 31 which is surrounded by a peripheral wall 32.

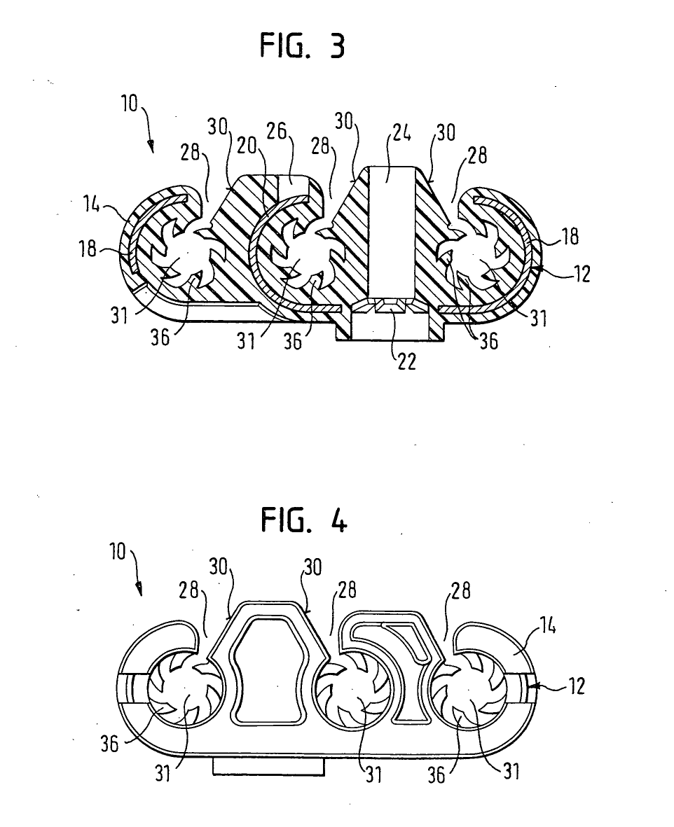

In the central region 34, each peripheral wall 32 is provided with sickle-like appendages 36. The appendages 36, six in each case, extend inwards (see FIG. 3). The appendages 36, which are designed to be flexible, can adapt to different line diameters. If a line with a large diameter is inserted, the appendages 36 are bent and abut the peripheral wall 32, whereas with a line with a small diameter, they are not, or only slightly, bent. In both cases, the appendages 36 exert holding forces on the line and the line is held securely and firmly.

Since the appendages 36 are only arranged in a central section 34 of the peripheral wall 32, the line inserted can already adapt to a change in direction adjacent to the attachment device 10 in the outer regions. Significant changes in direction are thus possible, without having to fold the line, which would reduce the life span of the line.

Either after or before fitting the lines, the attachment device 10 can be attached to the vehicle body by means of the bolt (not shown) which extends through the opening 24. The attachment device 10 could equally well be mounted to the vehicle body in a bore hole by means of a latching base (not shown).

When the attachment device 10 is installed, the risk of injury to a fitter is minimized because any sharp edges of the reinforcement part 12 are covered by the synthetic layer 14. Furthermore, the attachment device 10 can hold the lines securely over a long period of time due to the reinforcement part 12.

When producing the attachment device 10, the reinforcement part 12 is placed in an injection mold by an automatic feed. The synthetic layer 14 is injection-molded around the reinforcement part 12 so that the reinforcement part 12 is surrounded by the same apart from in those regions in which it was held in the injection molding die (FIGS. 2 and 4) and on the attachment section 22.

As already mentioned, and as can be seen in FIGS. 1, 3 and 4, the synthetic layer 14 fully surrounds the reinforcement part 12, with the exception of the attachment section 22. That is particularly, the synthetic layer 14 also surrounds the attachment device 10 on its end faces which are defined by the axes of the cylindrical recesses 31 (see FIGS. 1 and 4). On these end faces, the synthetic layer 14 forms a contiguous wall, which, on the one hand, decisively contributes to the overall stability of the attachment device 10 and, on the other hand, provides an optimum protection to the fitter from the edges on the end faces of the reinforcement part 12.

1. An attachment device for a plurality of lines, the attachment device comprising a reinforcement part and a synthetic layer which at least partially surrounds the reinforcement part, a respective retainer being provided for each line, the reinforcement part having a C-shaped section, as seen in cross-section, for each retainer, each C-shaped section surrounding the respective line spaced apart from the line.

2. The attachment device according to claim 1, wherein three retainers for three lines are provided.

3. The attachment device according to claim 1, wherein the reinforcement part has a flat section, and one of the C-shaped sections is formed by a central strip of the flat section, the central strip being stamped out and bent upwards.

4. The attachment device according to claim 1, wherein the retainers are formed by cylindrical recesses, all C-shaped sections extending at least about half the periphery of the recesses.

5. The attachment device according to claim 1, comprising an attachment section, the synthetic layer fully surrounding the reinforcement part except for the attachment section.

6. The attachment device according to claim 1, wherein the reinforcement part is made from metal.

7. The attachment device according to claim 1, wherein the reinforcement part is made from a synthetic material.

8. The attachment device according to claim 1, wherein the synthetic layer is injection-molded.

9. The attachment device according to claim 1, wherein gaps are provided for inserting the lines.

10. The attachment device according to claim 1, wherein each retainer has a peripheral wall which surrounds the inserted line and has flexible appendages extending inwards.

11. An attachment device for a line, the attachment device comprising a reinforcement part and a synthetic layer which at least partially surrounds the reinforcement part, the synthetic layer having a peripheral wall which surrounds the inserted line and has appendages extending inwards, the appendages having a sickle-like shape and being flexible.

12. The attachment device according to claim 11, wherein the sickle-like appendages bend dependent on the diameter of the inserted line.

13. The attachment device according to claim 11, comprising an attachment section, the synthetic layer fully surrounding the reinforcement part except for the attachment section.

14. The attachment device according to claim 11, wherein the reinforcement part is made from metal.

15. The attachment device according to claim 11, wherein the reinforcement part is made from a synthetic material.

16. The attachment device according to claim 11, wherein the reinforcement part has at least one C-shaped section, as seen in cross-section, which at least partly surrounds the line spaced apart from the line.

17. The attachment device according to claim 11, wherein the synthetic layer is injection-molded.

18. The attachment device according to claim 11, wherein a gap is provided for inserting the line.

19. The attachment device according to claim 11, wherein the attachment device accommodates several lines.

20. An attachment device for at least one line, the attachment device comprising a reinforcement part and a synthetic layer, the reinforcement part having an attachment section, the synthetic layer fully surrounding the reinforcement part except for the attachment section.

21. The attachment device according to claim 20, wherein a plurality of cylindrical recesses is provided, the synthetic layer forming a contiguous wall on the end faces of the attachment device which are defined by the axes of the cylindrical recesses.

22. The attachment device according to claim 20, wherein the reinforcement part is made from metal.

23. The attachment device according to claim 20, wherein the reinforcement part is made from a synthetic material.

24. The attachment device according to claim 20, wherein the reinforcement part has at least one C-shaped section, as seen in cross-section, which at least partially surrounds the line spaced apart from the line.

25. The attachment device according to claim 20, wherein the synthetic layer is injection-molded.

26. The attachment device according to claim 20, wherein a gap is provided for inserting the line.

27. The attachment device according to claim 20, wherein a peripheral wall, which surrounds the inserted line, has flexible appendages extending inwards.

28. The attachment device according to claim 20, wherein the attachment device accommodates several lines.

29. An attachment device for a line, the attachment device comprising a reinforcement part and a synthetic layer which at least partially surrounds the reinforcement part, the reinforcement part having an attachment section for a bolt, the synthetic layer having a cylindrical opening formed therein for accommodating the bolt.

30. The attachment device according to claim 29, wherein the opening extends over the whole height of the attachment device.

31. The attachment device according to claim 29, wherein the synthetic layer fully surrounds the reinforcement part except for axial end faces, in relation to the axis of the opening, of the attachment section.

32. The attachment device according to claim 29, wherein the reinforcement part is made from metal.

33. The attachment device according to claim 29, wherein the reinforcement part is made from a synthetic material.

34. The attachment device according to claim 29, wherein the reinforcement part has at least one C-shaped section, as seen in cross-section, which at least partly surrounds the line spaced apart from the line.

35. The attachment device according to claim 29, wherein the synthetic layer is injection-molded.

36. The attachment device according to claim 29, wherein a gap is provided for inserting the line.

37. The attachment device according to claim 29, wherein a peripheral wall, which surrounds the inserted line, has flexible appendages extending inwards.

38. The attachment device according to claim 29, wherein the attachment device accommodates several lines.
